(19) United States
(12) Patent Application Publication
(10) Pub. No.: US 2001/0055277 A1
(43) Pub. Date: Dec. 27, 2001

(54) Initiate flow control mechanism of a modular multiprocessor system

(76) Inventors: Simon C. Steely JR., Hudson, NH (US); Madhumitra Sharma, Marlborough, MA (US); Stephen R. Van Doren, Northborough, MA (US); Gregory E. Tierney, Chelmsford, MA (US)

Correspondence Address: CESARI AND MCKENNA, LLP, 88 BLACK FALCON AVENUE, BOSTON, MA, 02210, US

(21) Appl. No.: 09/853,301

(22) Filed: May 11, 2001

Related U.S. Application Data
(60) Provisional application No. 60/208,336, filed on May 31, 2000.
(60) Provisional application No. 60/208,231, filed on May 31, 2000.

(51) Int. Cl. H04L 12/26

(52) U.S. Cl. 370/236; 370/412

(57) ABSTRACT

An initiate flow control mechanism prevents interconnect resources within a switch fabric of a modular multiprocessor system from being dominated with initiate transactions. The multiprocessor system comprises a plurality of nodes interconnected by a switch fabric that extends from a global input port of a node through a hierarchical switch to a global output port of the same or another node. The interconnect resources include shared buffers within the global ports and hierarchical switch. The initiate flow control mechanism manages these shared buffers to reserve bandwidth for complete transactions when extensive global initiate traffic to one or more nodes of the system may create a bottleneck in the switch fabric.

### CROSS-REFERENCE TO RELATED APPLICATIONS

The present application claims priority from the following U.S. Provisional Patent Applications:

Ser. No. 60/208,336, which was filed on May 31, 2000, by Stephen Van Doren, Simon Steely, Jr., Madhumitra Sharma and Gregory Tierney for an INITIATE FLOW CONTROL MECHANISM OF A MODULAR MULTIPROCESSOR SYSTEM; and

Ser. No. 60/208,231, which was filed on May 31, 2000, by Stephen Van Doren, Simon Steely, Jr., Madhumitra Sharma and Gregory Tierney for a CREDIT-BASED FLOW CONTROL TECHNIQUE IN A MODULAR MULTIPROCESSOR SYSTEM, which are hereby incorporated by reference.

### BACKGROUND OF THE INVENTION

1. Field of the Invention

The present invention relates to computer systems and, more specifically, to an improved flow control mechanism of a modular multiprocessor system.

2. Background Information

In a modular multiprocessor system, many resources may be shared among the entities or “agents” of the system. These resources are typically configured to support a maximum bandwidth load that may be provided by the agents, such as processors, memory controllers or input/output (I/O) interface devices. In some cases, however, it is not practical to configure a resource to support peak bandwidth loads that infrequently arise in the presence of unusual traffic conditions. Resources that cannot support maximum system bandwidth under all conditions require complimentary flow control mechanisms that disallow the unusual traffic patterns resulting in peak bandwidth.

The agents of the modular multiprocessor system may be distributed over physically remote subsystems or nodes that are interconnected by a switch fabric. These modular systems may further be configured according to a distributed shared memory or symmetric multiprocessor (SMP) paradigm. Operation of a SMP system typically involves the passing of messages or packets as transactions between the agents of the nodes over interconnect resources of the switch fabric. To support various transactions in system, the packets are grouped into various types, such as commands or initiate packet transactions and responses or complete packet transactions. These groups of transactions are further mapped into a plurality of virtual channels that enable the transaction packets to traverse the system via similar interconnect resources.

Specifically, virtual channels are independently flow-controlled channels of transaction packets that share common interconnect and/or buffering resources. The transactions are grouped by type and mapped to the virtual channels to, inter alia, avoid system deadlock. That is, virtual channels are employed to avoid deadlock situations over the common sets of resources coupling the agents of the system. For example, rather than using separate links for each type of transaction packet forwarded through the system, the virtual channels are used to segregate that traffic over a common set of physical links.

In a SMP system having a switch fabric comprising interconnect resources, such as buffers, that are shared among virtual channels of the system, a situation may arise wherein one virtual channel dominates the buffers, thus causing the packets of other channels to merely “trickle through” those buffers. Such a trickling effect limits the performance of the entire SMP system. The present invention is generally directed to increasing the performance and bandwidth of the interconnect resources. More specifically, the invention is directed to managing traffic through the shared buffer resources in the switch fabric of the system.

### SUMMARY OF THE INVENTION

The present invention comprises an initiate flow control mechanism that prevents interconnect resources within a switch fabric of a modular multiprocessor system from being “dominated,” i.e., saturated, with initiate transactions. The multiprocessor system comprises a plurality of nodes interconnected by the switch fabric that extends from a global input port of a node through a hierarchical switch to a global output port of the same or another node. The interconnect resources include, inter alia, shared buffers within the global ports and hierarchical switch. The novel flow control mechanism manages these shared buffers to reserve bandwidth for complete transactions when extensive global initiate traffic to one or more nodes of the system may create a bottleneck in the switch fabric.

According to the invention, whenever the content of a shared buffer of a global input port exceeds a specific number of initiate packets, stop initiate flow control signals are sent to all nodes of the switch, thereby stalling any further issuance of initiate packets to the hierarchical switch. Although this may result in the shared buffer within a single target global input port being dominated by initiate traffic, the novel flow control mechanism prevents interconnect resources in the hierarchical switch from being overwhelmed by the same reference stream. This prevents the initiate traffic directed at the target global port from limiting its resultant complete traffic and, hence, its rate of progress. Thus, the invention detects a condition that arises when a shared buffer of a global port becomes dominated by initiate commands. Furthermore, the invention prevents congestion in the global port buffer from propagating into the shared buffer of the hierarchical switch by delaying further issuance of initiate commands from all system nodes to the hierarchical switch until the congestion in the shared buffer of the target global port is alleviated.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes interconnected by a hierarchical switch (HS);

FIG. 2 is a schematic block diagram of a QBB node coupled to the SMP system of FIG. 1;

FIG. 3 is a functional block diagram of circuits contained within a local switch of the QBB node of FIG. 2;

FIG. 4 is a schematic block diagram of the HS of FIG. 1;

FIG. 5 is a schematic block diagram of a switch fabric of the SMP system;

FIG. 6 is a schematic block diagram depicting a virtual channel queue arrangement of the SMP system;

FIG. 7 is a schematized block diagram of logic circuitry located within the local switch and HS of the switch fabric that may be advantageously used with the present invention; and

FIG. 8 is a schematic block diagram of a shared buffer within the switch fabric that may be advantageously used with the present invention.

### DETAILED DESCRIPTION OF AN ILLUSTRATIVE EMBODIMENT

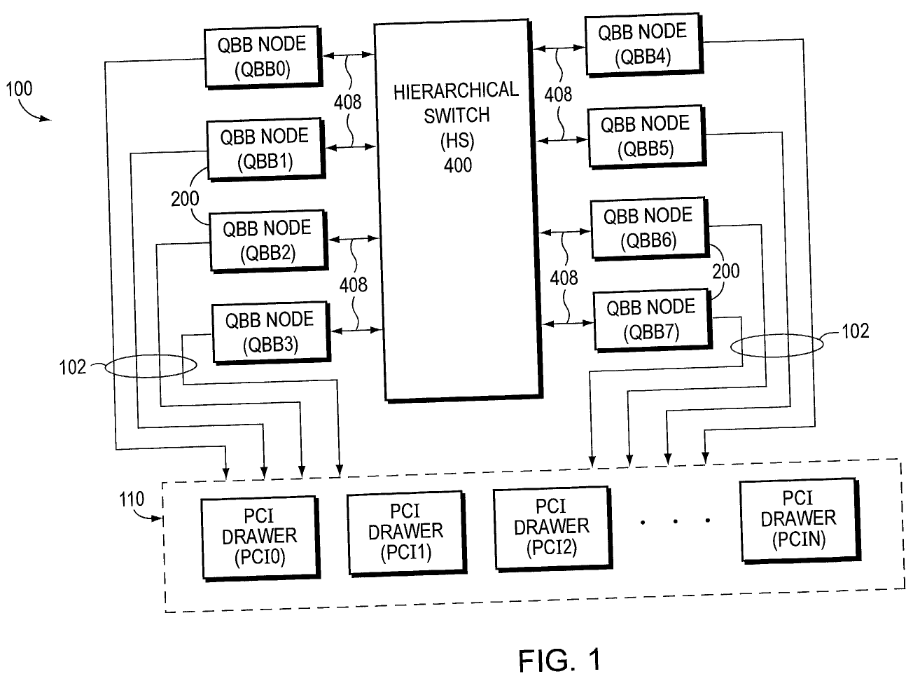

FIG. 1 is a schematic block diagram of a modular, symmetric multiprocessing (SMP) system 100 having a plurality of nodes 200 interconnected by a hierarchical switch (HS 400). The SMP system further includes an input/output (I/O) subsystem 110 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising, inter alia, a plurality of processors, a plurality of memory modules, an I/O port (IOP), a plurality of I/O risers and a global port (GP) interconnected by a local switch. Each memory module may be shared among the processors of a node and, further, among the processors of other QBB nodes configured on the SMP system to create a distributed shared memory environment. A fully configured SMP system preferably comprises eight (8) QBB (QBB0-7) nodes, each of which is coupled to the HS 400 by a full-duplex, bi-directional, clock forwarded HS link 408.

Data is transferred between the QBB nodes 200 of the system in the form of packets. In order to provide the distributed shared memory environment, each QBB node is configured with an address space and a directory for that address space. The address space is generally divided into memory address space and I/O address space. As described herein, the processors and IOP of each QBB node utilize private caches to store data for memory-space addresses; I/O space data is generally not “cached” in the private caches.

QBB Node Architecture

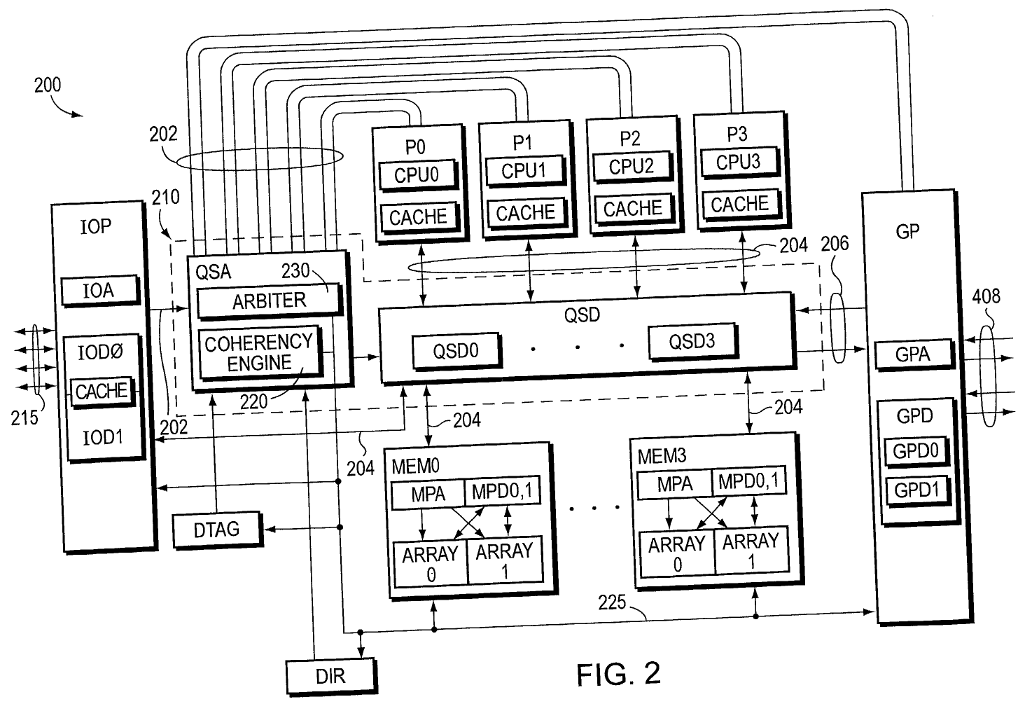

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node in the form of packets. As used herein, the term “system” refers to all components of the QBB node excluding the processors and IOP.

Each processor is a modern processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation of Houston, Tex., although other types of processor chips may be advantageously used. The load/store instructions executed by the processors are issued to the system as memory reference transactions, e.g., read and write operations. Each transaction may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be used in connection with the principles of the invention. It should be further noted that memory reference transactions issued by the processors are preferably directed to a 64-byte cache line granularity. Since the IOP and processors may update data in their private caches without updating shared memory, a cache coherence protocol is utilized to maintain data consistency among the caches.

The commands described herein are defined by the Alpha® memory system interface and may be classified into three types: requests, probes, and responses. Requests are commands that are issued by a processor when, as a result of executing a load or store instruction, it must obtain a copy of data. Requests are also used to gain exclusive ownership to a data item (cache line) from the system. Requests include Read (Rd) commmands Read/Modify (RdMod) commands, Change-to-Dirty (CTD) commands, Victim commands, and Evict commands, the latter of which specify removal of a cache line from a respective cache.

Probes are commands issued by the system to one or more processors requesting data and/or cache tag status updates. Probes include Forwarded Read (Frd) commands, Forwarded Read Modify (FRdMod) commands and Invalidate (Inval) commands. When a processor P issues a request to the system, the system may issue one or more probes (via probe packets) to other processors. For example if P requests a copy of a cache line (a Rd request), the system sends a Frd probe to the owner processor (if any). If P requests exclusive ownership of a cache line (a CTD request), the system sends Inval probes to one or more processors having copies of the cache line. If P requests both a copy of the cache line as well as exclusive ownership of the cache line (a RdMod request) the system sends a FRdMod probe to a processor currently storing a dirty copy of a cache line of data. In response to the FRdMod probe, the dirty copy of the cache line is returned to the system. A FRdMod probe is also issued by the system to a processor storing a dirty copy of a cache line. In response to the FRdMod probe, the dirty cache line is returned to the system and the dirty copy stored in the cache is invalidated. An Inval probe may be issued by the system to a processor storing a copy of the cache line in its cache when the cache line is to be updated by another processor.

Responses are commands from the system to processors and/or the IOP that carry the data requested by the processor or an acknowledgment corresponding to a request. For Rd and RdMod requests, the responses are Fill and FillMod responses, respectively, each of which carries the requested data. For a CTD request, the response is a CTD-Success (Ack) or CTD-Failure (Nack) response, indicating success or failure of the CTD, whereas for a Victim request, the response is a Victim-Release response.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IOD0-1) ASICs that collectively provide an I/O port interface from the I/O subsystem to the QBB node. Specifically, the IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS 400 via a set of unidirectional, clock forwarded address and data HS links 408.

A plurality of shared data structures are provided for capturing and maintaining status information corresponding to the states of data used by the nodes of the system. One of these structures is configured as a duplicate tag store (DTAG) that cooperates with the individual caches of the system to define the coherence protocol states of data cached in the QBB node. The other structure is configured as a directory (DIR) to administer the distributed shared memory environment including the other QBB nodes in the system. The protocol states of the DTAG and DIR are further managed by a coherency engine 220 of the QSA that interacts with these structures to maintain coherency of cache lines in the SMP system.

The DTAG, DIR, coherency engine, IOP, GP and memory modules are interconnected by a logical bus, hereinafter referred to as Arb bus 225. Memory and I/O reference operations issued by the processors are routed by a QSA arbiter 230 over the Arb bus 225. The coherency engine and arbiter are preferably implemented as a plurality of hardware registers and combinational logic configured to produce sequential logic circuits, such as state machines. It should be noted, however, that other configurations of the coherency engine, arbiter and shared data structures may be advantageously used herein.

Operationally, the QSA receives requests from the processors and IOP, and arbitrates among those requests (via the QSA arbiter) to resolve access to resources coupled to the Arb bus 225. If, for example, the request is a memory reference transaction, arbitration is performed for access to the Arb bus based on the availability of a particular memory module, array or bank within an array. In the illustrative embodiment, the arbitration policy enables efficient utilization of the memory modules; accordingly, the highest priority of arbitration selection is preferably based on memory resource availability. However, if the request is an I/O reference transaction, arbitration is performed for access to the Arb bus for purposes of transmitting that request to the IOP. In this case, a different arbitration policy may be utilized for I/O requests and control status register (CSR) references issued to the QSA.

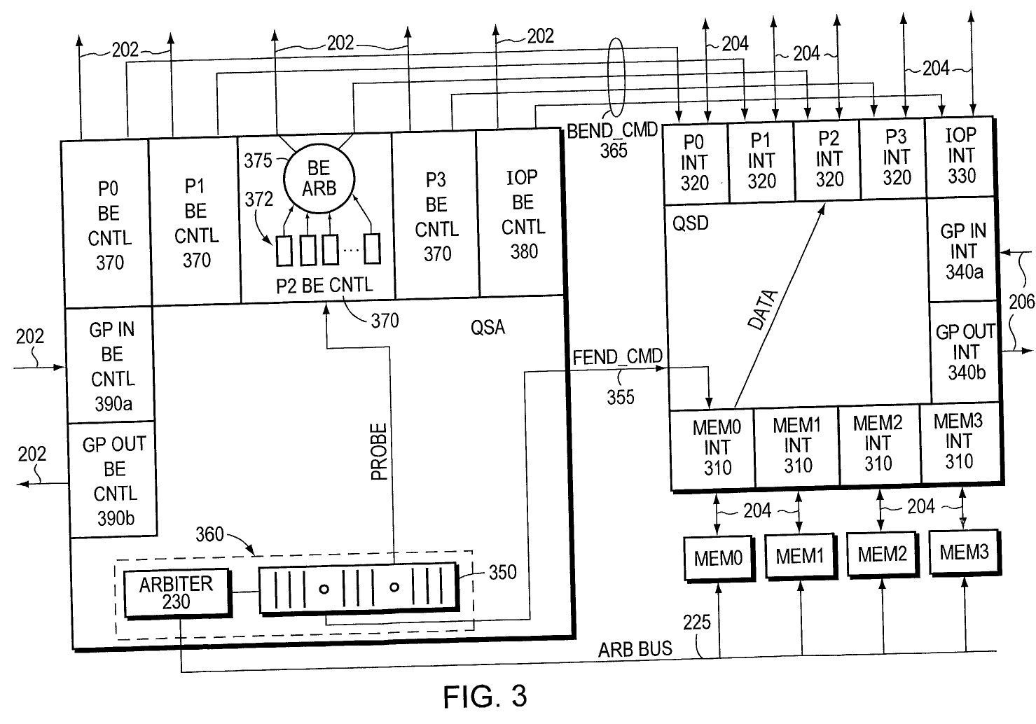

FIG. 3 is a functional block diagram of circuits contained within the QSA and QSD ASICs of the local switch of a QBB node. The QSD includes a plurality of memory (MEM0-3) interface circuits 310, each corresponding to a memory module. The QSD further includes a plurality of processor (P0-P3) interface circuits 320, an IOP interface circuit 330 and a plurality of GP input and output (GPIN and GPOUT) interface circuits 340a,b. These interface circuits are configured to control data transmitted to/from the QSD over the bi-directional clock forwarded links 204 (for P0-P3, MEM0-3 and IOP) and the unidirectional clock forwarded links 206 (for the GP). As described herein, each interface circuit also contains storage elements (i.e., queues) that provide limited buffering capabilities with the circuits.

The QSA, on the other hand, includes a plurality of processor controller circuits 370, along with IOP and GP controller circuits 380, 390. These controller circuits (hereinafter “back-end controllers”) function as data movement engines responsible for optimizing data movement between respective interface circuits of the QSD and the agents corresponding to those interface circuits. The back-end controllers carry-out this responsibility by issuing commands to their respective interface circuits over a back-end command (Bend_Cmd) bus 365 comprising a plurality of lines, each coupling a back-end controller to its respective QSD interface circuit. Each back-end controller preferably comprises a plurality of queues coupled to a back-end arbiter (e.g., a finite state machine) configured to arbitrate among the queues. For example, each processor back-end controller 370 comprises a back-end arbiter 375 that arbitrates among queues 372 for access to a command/address clock forwarded link 202 extending from the QSA to a corresponding processor.

The memory reference transactions issued to the memory modules are preferably ordered at the Arb bus 225 and propagate over that bus offset from each other. Each memory module services the operation issued to it by returning data associated with that transaction. The returned data is similarly offset from other returned data and provided to a corresponding memory interface circuit 310 of the QSD. Because the ordering of transactions on the Arb bus guarantees staggering of data returned to the memory interface circuits from the memory modules, a plurality of independent command/address buses between the QSA and QSD are not needed to control the memory interface circuits.

In the illustrative embodiment, only a single front-end command (Fend_Cmd) bus 355 is provided that cooperates with the QSA arbiter 230 and an Arb pipeline 350 to control data movement between the memory modules and corresponding memory interface circuits of the QSD.

The QSA arbiter and Arb pipeline preferably function as an Arb controller 360 that monitors the states of the memory resources and, in the case of the arbiter 230, schedules memory reference transactions over the Arb bus 225 based on the availability of those resources. The Arb pipeline 350 comprises a plurality of register stages that carry command/address information associated with the scheduled transactions over the Arb bus. In particular, the pipeline 350 temporarily stores the command/address information so that it is available for use at various points along the pipeline such as, e.g., when generating a probe directed to a processor in response to a DTAG look-up operation associated with stored command/address.

In the illustrative embodiment, data movement within a QBB node essentially requires two commands. In the case of the memory and QSD, a first command is issued over the Arb bus 225 to initiate movement of data from a memory module to the QSD. A second command is then issued over the front-end command bus 355 instructing the QSD how to proceed with that data. For example, a request (read transaction) issued by P2 to the QSA is transmitted over the Arb bus 225 by the QSA arbiter 230 and is received by an intended memory module, such as MEM0. The memory interface logic activates the appropriate SDRAM DIMM(s) and, at a predetermined later time, the data is returned from the memory to its corresponding MEMO interface circuit 310 on the QSD. Meanwhile, the Arb controller 360 issues a data movement command over the front-end command bus 355 that arrives at the corresponding MEM0 interface circuit at substantially the same time as the data is returned from the memory. The data movement command instructs the memory interface circuit where to move the returned data. That is, the command may instruct the MEM0 interface circuit to move the data through the QSD to the P2 interface circuit 320 in the QSD.

In the case of the QSD and a processor (such as P2), a fill command is generated by the Arb controller 360 and forwarded to the P2 back-end controller 370 corresponding to P2, which issued the read transaction. The controller 370 loads the fill command into a fill queue 372 and, upon being granted access to the command/address link 202, issues a first command over that link to P2 instructing that processor to prepare for arrival of the data. The P2 back-end controller 370 then issues a second command over the back-end command bus 365 to the QSD instructing its respective P2 interface circuit 320 to send that data to the processor.

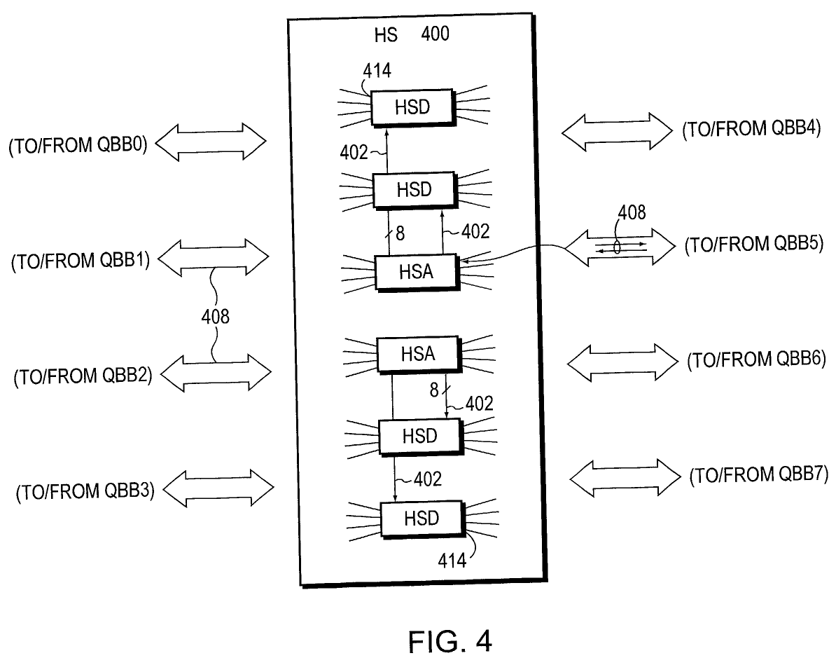

FIG. 4 is a schematic block diagram of the HS 400 comprising a plurality of HS address (HSA) ASICs and HS data (HSD) ASICs. Each HSA preferably controls a plurality of (e.g., two) HSDs in accordance with a master/slave relationship by issuing commands over lines 402 that instruct the HSDs to perform certain functions. Each HSA and HSD further includes eight (8) ports 414, each accommodating a pair of unidirectional interconnects; collectively, these interconnects comprise the HS links 408. In the illustrative embodiment, there are sixteen command/address paths in/out of each HSA, along with sixteen data paths in/out of each HSD. However, there are only sixteen data paths in/out of the entire HS; therefore, each HSD preferably provides a bit-sliced portion of that entire data path and the HSDs operate in unison to transmit/receive data through the switch. To that end, the lines 402 transport eight (8) sets of command pairs, wherein each set comprises a command directed to four (4) output operations from the HS and a command directed to four (4) input operations to the HS.

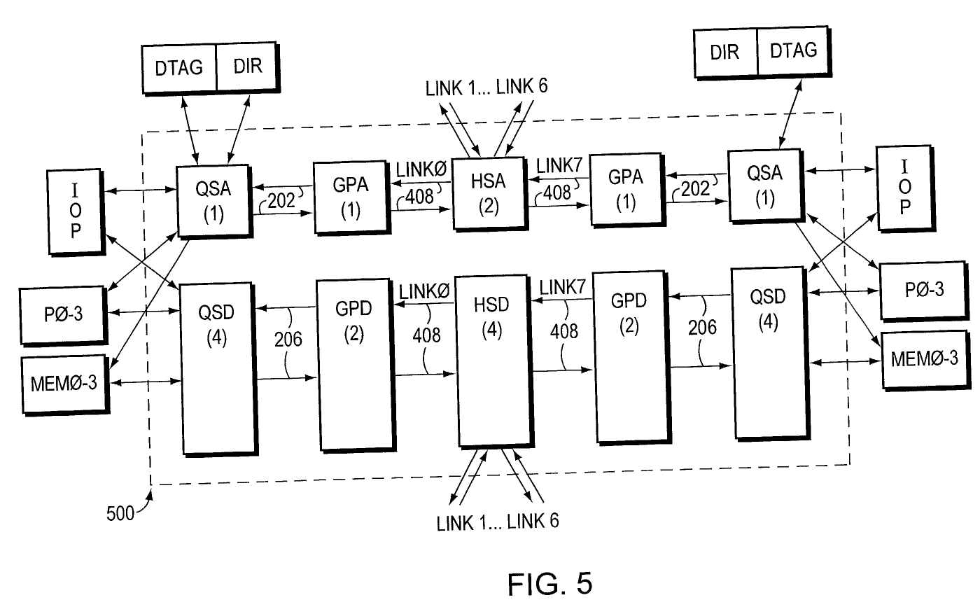

The local switch ASICs in connection with the GP and HS ASICs cooperate to provide a switch fabric of the SMP system. FIG. 5 is a schematic block diagram of the SMP switch fabric 500 comprising the QSA and QSD ASICs of local switches 210, the GPA and GPD ASICs of GPs, and the HSA and HSD ASICs of the HS 400. As noted, operation of the SMP system essentially involves the passing of messages or packets as transactions between agents of the QBB nodes 200 over the switch fabric 500. To support various transactions in system 100, the packets are grouped into various types, including processor command packets, command response packets and probe command packets.

These groups of packets are further mapped into a plurality of virtual channels that enable the transaction packets to traverse the system via similar interconnect resources of the switch fabric. However, the packets are buffered and subject to flow control within the fabric 500 in a manner such that they operate as though they are traversing the system by means of separate, dedicated resources. In the illustrative embodiment described herein, the virtual channels of the SMP system are manifested as queues coupled to a common set of interconnect resources. The present invention is generally directed to managing traffic over these resources (e.g., links and buffers) coupling the QBB nodes 200 to the HS 400. More specifically, the present invention is directed to increasing the performance and bandwidth of the interconnect resources.

Virtual Channels

Virtual channels are various, independently flow-controlled channels of transaction packets that share common interconnect and/or buffering resources. The transactions are grouped by type and mapped to the various virtual channels to, inter alia, avoid system deadlock. That is, virtual channels are employed in the modular SMP system primarily to avoid deadlock situations over the common sets of resources coupling the ASICs throughout the system. For example rather than having separate links for each type of transaction packet forwarded through the system, the virtual channels are used to segregate that traffic over a common set of physical links. Notably, the virtual channels comprise address/command paths and their associated data paths over the links.

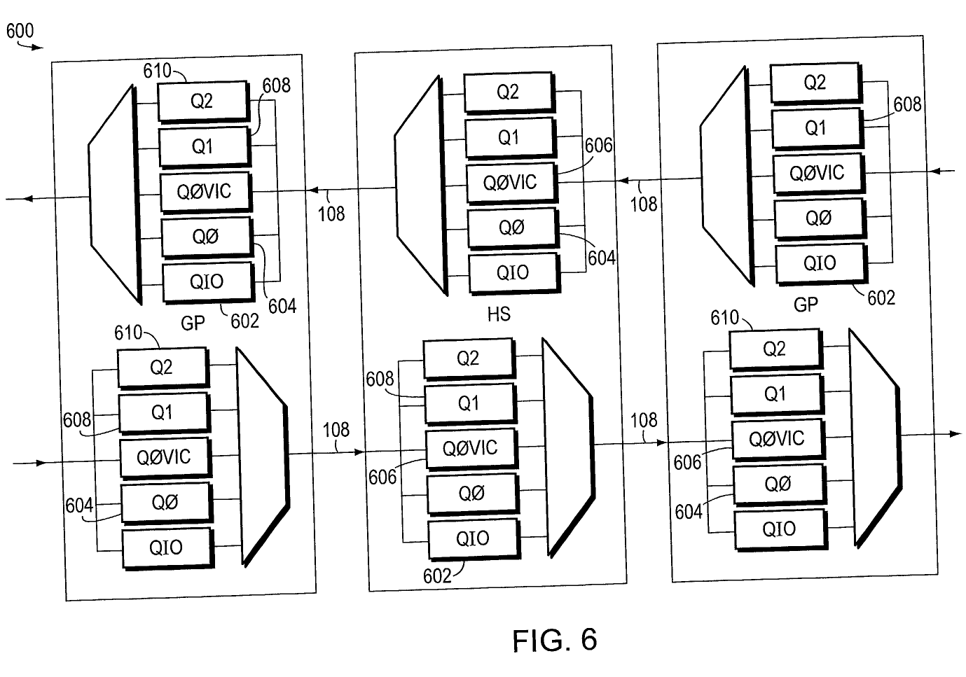

FIG. 6 is a schematic block diagram depicting a queue arrangement 600 wherein the virtual channels are manifested as a plurality of queues located within agents (e.g., the GPs and HS) of the SMP system. It should be noted that the queues generally reside throughout the entire “system” logic; for example, those queues used for the exchange of data are located in the processor interfaces 320, the IOP interfaces 330 and GP interfaces 340 of the QSD. However, the virtual channel queues described herein are located in the QSA, GPA and HSA ASICs, and are used for exchange of command, command response and command probe packets.

In the illustrative embodiment, the SMP system maps the transaction packets into five (5) virtual channel queues. A QIO channel queue 602 accommodates processor command packet requests for programmed input/output (PIO) read and write transactions, including CSR transactions, to I/O address space. A Q0 channel queue 604 carries processor command packet requests for memory space read transactions, while a Q0Vic channel queue 606 carries processor command packet requests for memory space write transactions. A Q1 channel 608 queue accommodates command response and probe packets directed to ordered responses for QIO, Q0 and Q0Vic requests and, lastly, a Q2 channel queue 610 carries command response packets directed to unordered responses for QIO, Q0 and Q0Vic request.

Each of the QIO, Q1 and Q2 virtual channels preferably has its own queue, while the Q0 and Q0Vic virtual channels may, in some cases, share a physical queue. In terms of flow control and deadlock avoidance, the virtual channels are preferably prioritized within the SMP system with the QIO virtual channel having the lowest priority and the Q2 virtual channel having the highest priority. The Q0 and Q0Vic virtual channels have the same priority which is higher than QIO, but lower than Q1 which, in turn, is lower than Q2.

Deadlock is avoided in the SMP system by enforcing two properties with regard to transaction packets and virtual channels: (1) a response to a transaction in a virtual channel travels in a higher priority channel; and (2) lack of progress in one virtual channel cannot impede progress in a second, higher priority virtual channel. The first property eliminates flow control loops wherein transactions in, e.g., the Q0 channel from X to Y are waiting for space in the Q0 channel from Y to X, and wherein transactions in the channel from Y to X are waiting for space in the channel from X to Y. The second property guarantees that higher priority channels continue to make progress in the presence of the lower priority blockage, thereby eventually freeing the lower priority channel.

The virtual channels are preferably divided into two groups: (i) an initiate group comprising the QIO, Q0 and Q0Vic channels, each of which carries request type or initiate command packets; and (ii) a complete group comprising the Q1 and Q2 channels, each of which carries complete type or command response packets associated with the initiate packets. For example, a source processor may issue a request (such as a read or write command packet) for data at a particular address x in the system. As noted, the read command packet is transmitted over the Q0 channel and the write command packet is transmitted over the Q0Vic channel. This arrangement allows commands without data (such as reads) to progress independently of commands with data (such as writes). The Q0 and Q0Vic channels may be referred to as initiate channels. The QIO channel is another initiate channel that transports requests directed to I/O address space (such as requests to CSRs and I/O devices).

A receiver of the initiate command packet may be a memory, DIR or DTAG located on the same QBB node as the source processor. The receiver may generate, in response to the request, a command response or probe packet that is transmitted over the Q1 complete channel. Notably, progress of the complete channel determines the progress of the initiate channel. The response packet may be returned directly to the source processor, whereas the probe packet may be transmitted to other processors having copies of the most current (up-to-date) version of the requested data. If the copies of data stored in the processors' caches are more up-to-date than the copy in memory, one of the processors, referred to as the “owner”, satisfies the request by providing the data to the source processor by way of a Fill response. The data/answer associated with the Fill response is transmitted over the Q2 virtual channel of the system.

Each packet includes a type field identifying the type of packet and, thus, the virtual channel over which the packet travels. For example, command packets travel over Q0 virtual channels, whereas command probe packets (such as FwdRds, Invals and SFills) travel over Q1 virtual channels and command response packets (such as Fills) travel along Q2 virtual channels. Each type of packet is allowed to propagate over only one virtual channel; however, a virtual channel (such as Q0) may accommodate various types of packets. Moreover, it is acceptable for a higher-level channel (e.g., Q2) to stop a lower-level channel (e.g., Q1) from issuing requests/probes when implementing flow control; however, it is unacceptable for a lower-level channel to stop a higher-level channel since that would create a deadlock situation.

Requests transmitted over the Q0, Q0Vic and QIO channels are also called initiators that, in accordance with the present invention, are impacted by an initiate flow control mechanism that limits the flow of initiators within the system. As described herein, the initiate flow control mechanism allows Q1 and Q2 responders to alleviate congestion throughout the channels of the system. The novel initiate flow control mechanism is particularly directed to packets transmitted among GPs of QBB nodes through the HS; yet, flow control and general management of the virtual channels within a QBB node may be administered by the QSA of that node.

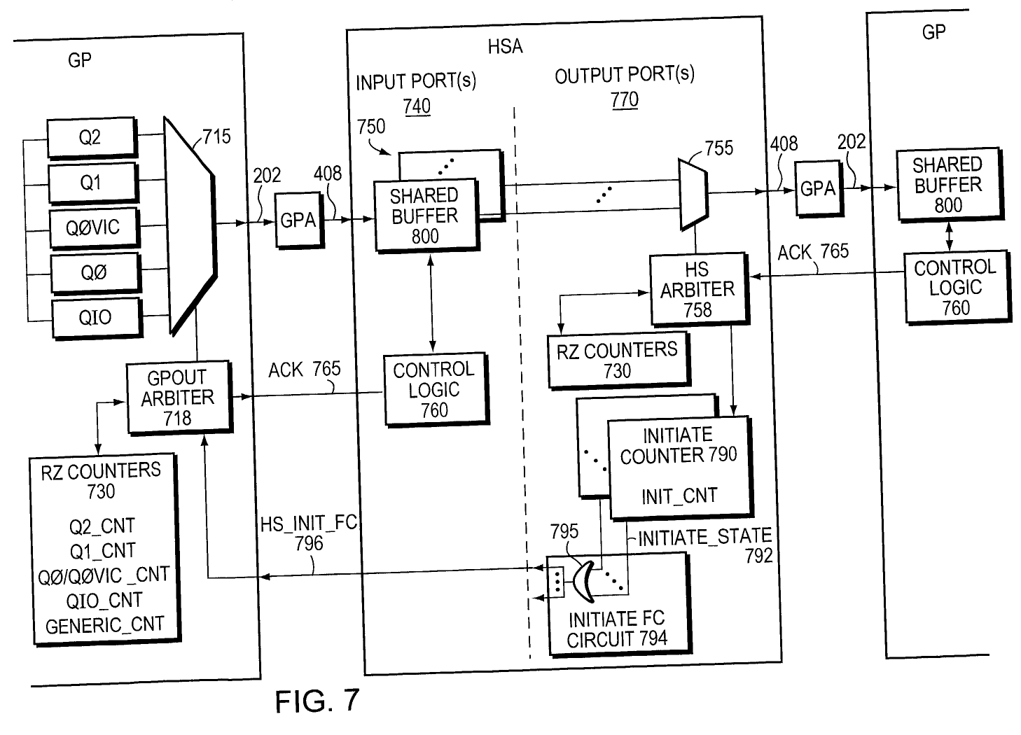

FIG. 7 is a schematized block diagram of logic circuitry located within the GPA and HSA ASICs of the switch fabric in the SMP system. The GPA comprises a plurality of queues organized similar to the queue arrangement 600. Each queue is associated with a virtual channel and is coupled to an input of a GPOUT selector circuit 715 having an output coupled to HS link 408. A finite state machine functioning as, e.g., a GPOUT arbiter 718 arbitrates among the virtual channel queues and enables the selector to select a command packet from one of its queue inputs in accordance with a forwarding decision. The GPOUT arbiter 718 preferably renders the forwarding decision based on predefined ordering rules of the SMP system, together with the availability and scheduling of commands for transmission from the virtual channel queues over the HS link.

The selected command is driven over the HS link 408 to an input buffer arrangement 750 of the HSA. The HS is a significant resource of the SMP system that is used to forward packets between the QBB nodes of the system. The HS is also a shared resource that has finite logic circuits (“gates”) available to perform the packet forwarding function for the SMP system. Thus, instead of having separate queues for each virtual channel, the HS utilizes a shared buffer arrangement 750 that conserves resources within the HS and, in particular, reduces the gate count of the HSA and HSD ASICs. Notably, there is a data entry of a shared buffer in the HSD that is associated with each command entry of the shared buffer in the HSA. Accordingly, each command entry in the shared buffer 800 can accommodate a full packet regardless of its type, while the corresponding data entry in the HSD can accommodate a 64-byte block of data associated with the packet.

The shared buffer arrangement 750 comprises a plurality of HS buffers 800, each of which is shared among the five virtual channel queues of each GPOUT controller 390b. The shared buffer arrangement 750 thus preferably comprises eight (8) shared buffers 800 with each buffer associated with a GPOUT controller of a QBB node 200. Buffer sharing within the HS is allowable because the virtual channels generally do not consume their maximum capacities of the buffers at the same time. As a result, the shared buffer arrangement is adaptable to the system load and provides additional buffering capacity to a virtual channel requiring that capacity at any given time. In addition, the shared HS buffer 800 may be managed in accordance with the virtual channel deadlock avoidance rules of the SMP system.

The packets stored in the entries of each shared buffer 800 are passed to an output port 770 of the HSA. The HSA has an output port 770 for each QBB node (i.e., GPIN controller) in the SMP system. Each output port 770 comprises an HS selector circuit 755 having a plurality of inputs, each of which is coupled to a buffer 800 of the shared buffer arrangement 750. An HS arbiter 758 enables the selector 755 to select a command packet from one of its buffer inputs for transmission to the QBB node. An output of the HS selector 755 is coupled to HS link 408 which, in turn, is coupled to a shared buffer of a GPA. As described herein, the shared GPIN buffer is substantially similar to the shared HS buffer 800.

The association of a packet type with a virtual channel is encoded within each command contained in the shared HS and GPIN buffers. The command encoding is used to determine the virtual channel associated with the packet for purposes of rendering a forwarding decision for the packet. As with the GPOUT arbiter 718, the HS arbiter 758 renders the forwarding decision based on predefined ordering rules of the SMP system, together with the availability and scheduling of commands for transmission from the virtual channel queues over the HS link 408.

An arbitration policy is invoked for the case when multiple commands of different virtual channels concurrently meet the ordering rules and the availability requirements for transmission over the HS link 408. For nominal operation, i.e., when not in the Init_State as described below, the preferred arbitration policy is an adaptation of a round-robin selection, in which the most recent virtual channel chosen receives the lowest priority. This adapted round-robin selection is also invoked by GPOUT arbiter 718 during nominal operation.

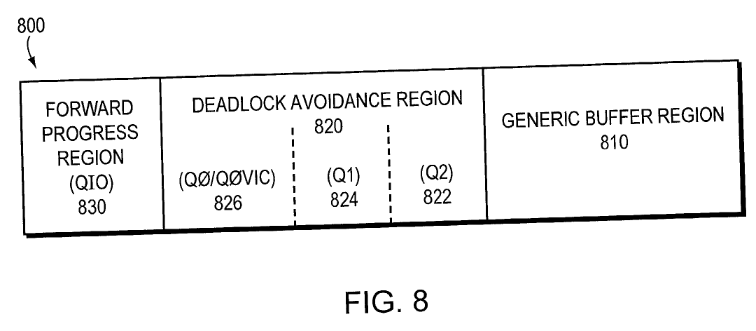

FIG. 8 is a schematic block diagram of the shared buffer 800 comprising a plurality of entries associated with various regions of the buffer. The buffer regions preferably include a generic buffer region 810, a deadlock avoidance region 820 and a forward progress region 830. The generic buffer region 810 is used to accommodate packets from any virtual channel, whereas the deadlock avoidance region 820 includes three entries 822-826, one each for Q2, Q1 and Q0/Q0Vic virtual channels. The three entries of the deadlock avoidance region allow the Q2, Q1 and Q0/Q0Vic virtual channel packets to progress through the HS 400 regardless of the number of QIO, Q0/Q0Vic and Q1 packets that are temporarily stored in the generic buffer region 810. The forward progress region 830 guarantees timely resolution of all QIO transactions, including CSR write transactions used for posting interrupts in the SMP system, by allowing QIO packets to progress through the SMP system.

It should be noted that the deadlock avoidance and forward progress regions of the shared buffer 800 may be implemented in a manner in which they have fixed correspondence with specific entries of the buffer. They may, however, also be implemented as in a preferred embodiment where a simple credit-based flow control technique allows their locations to move about the set of buffer entries.

Because the traffic passing through the HS may vary among the virtual channel packets, each shared HS buffer 800 requires elasticity to accommodate and ensure forward progress of such varying traffic, while also obviating deadlock in the system. The generic buffer region 810 addresses the elasticity requirement, while the deadlock avoidance and forward progress regions 820, 830 address the deadlock avoidance and forward progress requirements, respectively. In the illustrative embodiment, the shared buffer comprises eight (8) transaction entries with the forward progress region 830 occupying one QIO entry, the deadlock avoidance region 820 consuming three entries and the generic buffer region 810 occupying four entries.

As described herein, there are preferably two classes of shared buffers that share resources among virtual channels and provide deadlock avoidance and forward progress regions. Collectively, these buffers are referred to as “channel-shared buffers” or CSBs. The two classes of CSBs are single source CSBs (SSCSBs) and multiple source CSBs (MSCSBs). SSCSBs are buffers having a single source of traffic but which allow multiple virtual channels to share resources. MSCSBs are buffers that allow multiple sources of traffic, as well as multiple virtual channels to share resources.

A first embodiment of the SMP system may employ SSCSBs in both the HS and GP. This embodiment supports traffic patterns with varied virtual channel packet type composition from each source GPOUT to each destination GPIN. The flexibility to support varied channel reference patterns allows the buffer arrangement to approximate the performance of a buffer arrangement having a large number of dedicated buffers for each virtual channel. Dedicating buffers to a single source of traffic substantially simplifies their design.

A second embodiment may also employ SSCSBs in the GPIN logic and a MSCSB in the HS. This embodiment also supports varied channel traffic patterns effectively, but also supports varying traffic levels from each of the eight HS input ports more effectively. Sharing of buffers between multiple sources allows the MSCSB arrangement to approximate performance of a much larger arrangement of buffers in cases where the GPOUT circuits can generate traffic bandwidth that a nominally-sized SSCSB is unable to support, but where all GPOUT circuits cannot generate this level of traffic at the same time. This provides performance advantage over the first embodiment in many cases, but introduces design complexity.

The first embodiment has a fundamental flow control problem that arises when initiate packets consume all or most of the generic buffers in either an HS or GPIN SSCSB. There are two common examples of this problem. The first example occurs when the initiate packets that dominate a shared buffer of a GPIN result in Q1 complete packets that “multicast” a copy of the packet back to that GPIN. If the GPIN's shared buffer is dominated by initiate packets, the progress of the Q1 packets is constrained by the bandwidth in the Q1 dedicated slot and any residual generic slots in the GPIN's shared buffer. As the limited Q1 packets back up and begin to further limit the progress of initiate packets that generate them, the entire system slows to the point that it is limited by the bandwidth available to the Q1 packets.

Similarly, if a processor on a first QBB node “floods” a second node with initiate traffic as a processor on the second node floods the first node with initiate traffic, it is possible for the processor on the first node to dominate its associated HS buffer and the second node's GPIN buffer with initiate traffic while the processor on the second node dominates its associated HS buffer and the first node's GPIN buffer with initiate traffic. Even if the Q1 packets resulting from the initiate packets do not multicast, the Q1 packets from the first node are constrained from making progress through the first node's associated HS buffer and second node's GPIN buffer. The Q1 packets from the second node suffer in the same manner.

The second embodiment suffers the same initiate-oriented flow control problems as the first embodiment, as well as some additional initiate-oriented flow control problems. With the SSCSB in the HS, either a single “hot” node with multicast or a pair of hot nodes, each targeted by the other, is required to create a flow control problem. With the MSCSB in the HS, a single hot node, targeted by more than one other node with no reciprocal hot node or multicasting, is sufficient to create a problem. In this case, since the buffer is shared, the initiate packets that target a node and the complete packets that are issued by the node do not travel through separate buffers. Therefore, only the main buffer need be clogged by initiate packets to degrade system bandwidth.

According to the invention, the initiate flow control mechanism solves these problems. In a canonical embodiment, the initiate flow control mechanism does not allow either the HS or GPIN buffers to be dominated by initiate packets. This canonical solution may be implemented either with initiate flow control spanning from the GPIN buffer back to all GPOUT buffers or in a piece-meal manner by having the GPIN “back pressure” the HS and the HS back pressure the GPOUT.

In the preferred embodiment, the initiate flow control mechanism allows the GPIN buffer to become dominated by initiate packets, but does not allow the HS buffers to do so. Since the flow control mechanism spans between the GPIN and GPOUT, the latency involved in the flow control creates a natural hysteresis at the GPIN that provides bursts of complete packet access to the buffer and smoothes out the packet mix.

The second embodiment (with MSCSB in the HS) also suffers a fundamental flow control problem with respect to allowing multiple virtual channels to share buffer resources. Since dedicated (deadlock avoidance and forward progress) buffers are directly associated with specific GPOUT sources, while generic buffers are shared between multiple GPOUT sources, each GPOUT can effectively track the state of its associated dedicated buffers by means of source flow control, but cannot track the state of the generic buffers by means of source flow control. In other words, each GPOUT can track the number of generic buffers it is using, but cannot track the state of all generic buffers.

A solution to this problem is to provide a single flow control signal that is transmitted to each GPOUT indicating that the generic buffers are nearly exhausted. This signal is asserted such that all packets that are (or will be) “in flight” at the time the GPOUTs can respond are guaranteed space in the dedicated buffers. For eight sources and a multi-cycle flow control latency, this simple scheme leaves many buffers poorly utilized.

Global transfers in the SMP system, i.e., the transfer of packets between QBB nodes, are governed by flow control and arbitration rules at the GP and HS. The arbitration rules specify priorities for channel traffic and ensure fairness. Flow control, on the other hand, is divided into two independent mechanisms, one to prevent buffer overflow and deadlock (i.e., the RedZone_State) and the other to enhance performance (i.e., the Init_State). The state of flow control effects the channel arbitration rules.

RedZone Flow Control

The logic circuitry and shared buffer arrangement shown in FIG. 7 cooperate to provide a “credit-based” flow control mechanism that utilizes a plurality of counters to essentially create the structure of the shared buffer 800. That is, the shared buffer does not have actual dedicated entries for each of its various regions. Rather, counters are used to keep track of the number of packets per virtual channel that are transferred, e.g., over the HS link 408 to the shared HS buffer 800. The GPA preferably keeps track of the contents of the shared HS buffer 800 by observing the virtual channels over which packets are being transmitted to the HS.

Broadly stated, each sender (GP or HS) implements a plurality of RedZone (RZ) flow control counters, one for each of the Q2, Q1 and QIO channels, one that is shared between the Q0 and Q0Vic channels, and one generic buffer counter. Each receiver (HS or GP, respectively) implements a plurality of acknowledgement (Ack) signals, one for each of the Q2, Q1, Q0, Q0Vic and QIO channels. These resources, along with the shared buffer, are used to implement a RedZone flow control technique that guarantees deadlock-free operation for both a GP-to-HS communication path and an HS-to-GP path.

The GPOUT-to-HS Path

As noted, the shared buffer arrangement 750 comprises eight, 8-entry shared buffers 800, and each buffer may be considered as being associated with a GPOUT controller 390b of a QBB node 200. In an alternate embodiment of the invention, four 16-entry buffers may be utilized, wherein each buffer is shared between two GPOUT controllers. In this case, each GPOUT controller is provided access to only 8 of the 16 entries. When only one GPOUT controller is connected to the HS buffer, however, the controller 390b may access all 16 entries of the buffer. Each GPA coupled to an input port 740 of the HS is configured with a parameter (HS_Buf_Level) that is assigned a value of eight or sixteen indicating the HS buffer entries it may access. The value of sixteen may be used only in the alternate, 16-entry buffer embodiment where global ports are connected to at most one of every adjacent pair of HS ports. The following portion of a RedZone algorithm (i.e., the GP-to-HS path) is instantiated for each GP connected to the HS, and is implemented by the GPOUT arbiter 718 and HS control logic 760.

In an illustrative embodiment, the GPA includes a plurality of RZ counters 730:

(i) HS_Q2_Cnt, (ii) HS_Q1_Cnt, (iii) HS_Q0/Q0Vic_Cnt, (iv) HS_QIO_Cnt, and (v) HS_Generic_Cnt counters. Each time the GPOUT controller issues a Q2, Q1, Q0/Q0Vic or QIO packet to the HS 400, it increments, respectively, one of the HS_Q2_Cnt, HS_Q1_Cnt, HS_Q0/Q0Vic_Cnt or HS_QIO_Cnt counters. Each time the GPA issues a Q2, Q1, or Q0/Q0Vic packet to the HS and the previous value of the respective counter HS_Q2_Cnt, HS_Q1_Cnt or HS_Q0/Q0Vic_Cnt is equal to zero, the packet is assigned to the associated entry 822-826 of the deadlock avoidance region 820 in the shared buffer 800. Each time the GPA issues a QIO packet to the HS and the previous value of the HS_QIO_Cnt counter is equal to zero, the packet is assigned to the entry of the forward progress region 830.

On the other hand, each time the GPA issues a Q2, Q1, Q0/Q0Vic or QIO packet to the HS and the previous value of the respective HS_Q2_Cnt, HS_Q1_Cnt, HS_Q0/Q0Vic_Cnt or HS_QIO_Cnt counter is non-zero, the packet is assigned to an entry of the generic buffer region 810. As such, the GPOUT arbiter 718 increments the HS_Generic_Cnt counter in addition to the associated HS_Q2_Cnt, HS_Q1_Cnt, HS_Q0/Q0Vic_Cnt or HS_QIO_Cnt counter. When the HS_Generic_Cnt counter reaches a predetermined value, all entries of the generic buffer region 810 in the shared buffer 800 for that GPA are full and the input port 740 of the HS is defined to be in the RedZone_State. When in this state, the GPA may issue requests to only unused entries of the deadlock avoidance and forward progress regions 820, 830. That is, the GPA may issue a Q2, Q1, Q0/Q0Vic or QIO packet to the HS only if the present value of the respective HS_Q2_Cnt, HS_Q1_Cnt, HS_Q0/Q0Vic_Cnt or HS_QIO_Cnt counter is equal to zero.

Each time a packet is issued to an output port 770 of the HS, the control logic 760 of the HS input port 740 deallocates an entry of the shared buffer 800 and sends an Ack signal 765 to the GPA that issued the packet. The Ack is preferably sent to the GPA as one of a plurality of signals, e.g., HS_Q2_Ack, HS_Q1_Ack, HS_Q0_Ack, HS_Q0vic_Ack and HS_QIO_Ack, depending upon the type of issued packet. Upon receipt of an Ack signal, the GPOUT arbiter 718 decrements at least one RZ counter 730. For example, each time the arbiter 718 receives a HS_Q2_Ack, HS_Q1_Ack, HS_Q0_Ack, HS_Q0Vic_Ack or HS_QIO_Ack signal, it decrements the respective HS_Q2_Cnt, HS_Q1_Cnt, HS_Q0/Q0Vic_Cnt or HS_QIO_Cnt counter. Moreover, each time the arbiter receives a HS_Q2_Ack, HS_Q1_Ack, HS_Q0_Ack, HS_Q0Vic_Ack or HS_QIO_Ack signal and the previous value of the respective HS_Q2_Cnt, HS_Q1_Cnt, HS_Q0/Q0Vic_Cnt or HS_QIO_Cnt counter has a value greater than one (i.e., the successive value of the counter is non-zero), the GPOUT arbiter 718 also decrements the HS_Generic_Cnt counter.

The HS-to-GPIN Path

The credit-based, flow control technique for the HS-to-GPIN path is substantially identical to that of the GPOUT-to-HS path in that the shared GPIN buffer 800 is managed in the same way as the shared HS buffer 800. That is, there is a set of RZ counters 730 within the output port 770 of the HS that create the structure of the shared GPIN buffer 800. When a command is sent from the output port 770 over the HS link 408 and onto the shared GPIN buffer 800, a counter 730 is incremented to indicate the respective virtual channel packet sent over the HS link. When the virtual channel packet is removed from the shared GPIN buffer, Ack signals 765 are sent from GPIN control logic 760 of is the GPA to the output port 770 instructing the HS arbiter 758 to decrement the respective RZ counter 730. Decrementing of a counter 730 indicates that the shared buffer 800 can accommodate another respective type of virtual channel packet.

In the illustrative embodiment, however, the shared GPIN buffer 800 has sixteen (16) entries, rather than the eight (8) entries of the shared HS buffer. The parameter indicating which GP buffer entries to access is the GPin_Buf_Level. The additional entries are provided within the generic buffer region 810 to increase the elasticity of the buffer 800, thereby accommodating additional virtual channel commands. The portion of the RedZone algorithm described below (i.e., the HS-to-GPIN path) is instantiated eight times, one for each output port 770 within the HS 400, and is implemented by the HS arbiter 758 and GPIN control logic 760.

In the illustrative embodiment, each output port 770 includes a plurality of RZ counters 730: (i) GP_Q2_Cnt, (ii) GP_Q1_Cnt, (iii) GP_Q0/Q0Vic_Cnt, (iv) GP_QIO_Cnt and (v) GP_Generic_Cnt counters. Each time the HS issues a Q2, Q1, Q0/Q0Vic, or QIO packet to the GPA, it increments, respectively, one of the GP_Q2_Cnt, GP_Q1_Cnt, GP_Q0/Q0Vic_Cnt or GP_QIO_Cnt counters. Each time the HS issues a Q2, Q1, or Q0/Q0Vic to the GPIN and the previous value of the respective GP_Q2_Cnt, GP_Q1_Cnt, or Q0/Q0Vic_Cnt counter is equal to zero, the packet is assigned to the associated entry of the deadlock avoidance region 820 in the shared buffer 800. Each time the HS issues a QIO packet to the GPIN controller 390a and the previous value of the GP_QIO_Cnt counter is equal to zero, the packet is assigned to the entry of the forward progress region 830.

On the other hand, each time the HS issues a Q2, Q1, Q0/Q0Vic or QIO packet to the GPA and the previous value of the respective GP_Q2_Cnt, GP_Q1_Cnt, GP_Q0/Q0Vic_Cnt or GP_QIO_Cnt is non-zero, the packet is assigned to an entry of the generic buffer region 810 of the GPIN buffer 880. As such, the HS arbiter 758 increments the GP_Generic_Cnt counter, in addition to the associated GP_Q2_Cnt, GP_Q1_Cnt, GP_Q0Vic_Cnt or GP_QIO_Cnt counter. When the GP_Generic_Cnt counter reaches a predetermined value, all entries of the generic buffer region 810 in the shared GPIN buffer 800 are full and the output port 770 of the HS is defined to be in the RedZone_State. When in this state, the output port 770 may issue requests to only unused entries of the deadlock avoidance and forward progress regions 820, 830. That is, the output port 770 may issue a Q2, Q1, Q0/Q0Vic or QIO packet to the GPIN controller 390a only if the present value of the respective GP_Q2_Cnt, GP_Q1_Cnt, GP_Q0/Q0Vic_Cnt or GP_QIO_Cnt counter is equal to zero.

Each time a packet is retrieved from the shared GPIN buffer 800, control logic 760 of the GPA deallocates an entry of that buffer and sends an Ack signal 765 to the output port 770 of the HS 400. The Ack signal 765 is sent to the output port 770 as one of a plurality of signals, e.g., GP_Q2_Ack, GP_Q1_Ack, GP_Q0_Ack, GP_Q0Vic_Ack and GP_QIO_Ack, depending upon the type of issued packet. Upon receipt of an Ack signal, the HS arbiter 758 decrements at least one RZ counter 730. For example, each time the HS arbiter receives a GP_Q2_Ack, GP_Q1_Ack, GP_Q0_Ack, GP_Q0Vic_Ack or GP_QIO_Ack signal, it decrements the respective GP_Q2_Cnt, GP_Q1_Cnt, GP_Q0/Q0Vic_Cnt or GP_Generic_Cnt counter. Moreover, each time the arbiter receives a GP_Q2_Ack, GP_Q1_Ack, GP_Q0_Ack, GP_Q0Vic_Ack or GP_QIO_Ack signal and the previous value of the respective GP_Q2_Cnt, GP_Q1_Cnt, GP_Q0/Q0Vic_Cnt or GP_Generic_Cnt counter has a value greater than one (i.e., the successive value of the counter is non-zero), the HS arbiter 758 decrements the GP_Generic_Cnt counter.

The GPOUT and HS arbiters implement the RedZone algorithms described above by, inter alia, examining the RZ counters and transactions pending in the virtual channel queues, and determining whether those transactions can make progress through the shared buffers 800. If an arbiter determines that a pending transaction/reference can progress, it arbitrates for that reference to be loaded into the buffer. If, on the other hand, the arbiter determines that the pending reference cannot make progress through the buffer, it does not arbitrate for that reference.

Specifically, anytime a virtual channel entry of the deadlock avoidance region 820 is free (as indicated by the counter associated with that virtual channel equaling zero), the arbiter can arbitrate for the channel because the shared buffer 800 is guaranteed to have an available entry for that packet. If the deadlock avoidance entry is not free (as indicated by the counter associated with that virtual channel being greater than zero) and the generic buffer region 810 is full, then the packet is not forwarded to the HS because there is no entry available in the shared buffer for accommodating the packet. Yet, if the deadlock avoidance entry is occupied but the generic buffer region is not full, the arbiter can arbitrate to load the virtual channel packet into the buffer.

The RedZone algorithms represent a first level of arbitration for rendering a forwarding decision for a virtual channel packet that considers the flow control signals to determine whether there is sufficient room in the shared buffer for the packet. If there is sufficient space for the packet, a next determination is whether there is sufficient bandwidth on other interconnect resources (such as the HS links) coupling the GP and HS. If there is sufficient bandwidth on the links, then the arbiter implements an arbitration algorithm to determine which of the remaining virtual channel packets may access the HS links. An example of the arbitration algorithm implemented by the arbiter is a “not most recently used” algorithm.

For workloads wherein the majority of references issued by the processors in the SMP system address memory locations within their QBB nodes and wherein the remaining references that address other QBB nodes are distributed evenly between the other QBB nodes, the shared buffers 800 provide substantial performance. If, however, the distribution of references is biased towards a single QBB node (i.e., a “hot” node) or if the majority of the references issued by the processors address other QBB nodes, performance suffers. In the former case, the QBB node is the target of many initiate transactions and the source of many complete transactions.

For example, assume a QBB node and its GPIN controller are the targets of substantial initiate transactions, such as Q0 packet requests. Once the Q0 packets start flowing to the QBB node, the Q0 entries of the deadlock avoidance regions and the entire generic buffer regions of the shared buffers in the HS and GPIN controller become saturated with the initiate transactions. After some latency, the GPOUT controller of the QBB node issues complete transactions, such as Q1 packets, to the HS in response to the initiate traffic. Since the shared buffers are “stacked-up” with Q0 packets, only the Q1 entries of the deadlock avoidance regions are available for servicing the complete transactions. Accordingly, the Q1 packets merely “trickle through” the shared buffers and the SMP system is effectively reduced to the bandwidth provided by one entry of the buffer. As a result, the complete transactions are transmitted at less than maximum bandwidth and, accordingly, the overall progress of the system suffers. The present invention is directed to eliminating a situation wherein the generic buffer regions of the shared buffers become full with Q0 packets and, in fact, reserves space within the shared buffers for Q1 packets to make progress throughout the system.

Initiate Flow Control

In accordance with the present invention, an initiate flow control mechanism prevents interconnect resources, such as the shared buffers, within the switch fabric of the SMP system from being continuously “dominated,” i.e., saturated, with initiate transactions. To that end, the novel mechanism manages the shared buffers to reserve bandwidth for complete transactions when extensive global initiate traffic to one or more nodes of the system may create a bottleneck in the switch fabric. That is, the initiate flow control mechanism reserves interconnect resources within the switch fabric of the SMP system for complete transactions (e.g., Q1 and Q2 packets) in light of heavy global initiate transactions (e.g., Q0 packets) to a QBB node of the system.

Specifically whenever the content of a shared GPIN buffer exceeds a specific number of Q0 packets, stop initiate flow control signals are sent to all QBB nodes stalling further issuance of initiator packets to the generic buffer region 810 of the shared buffer 800 of the HS. Nonetheless, in the preferred embodiment, initiator packets are still issued to the forward progress region 830 (for QIO initiator packets) and to the deadlock avoidance region 820 (for Q0 and Q0Vic initiator packets). Although this may result in the shared GPIN buffer being overwhelmed with initiate traffic, the novel flow control mechanism prevents other interconnect resources of the switch fabric, e.g., the HS 400, from being overwhelmed with such traffic. Once the Q1 and Q2 transactions have completed, i.e., been transmitted through the switch fabric in accordance with a forwarding decision, thereby eliminating the potential bottleneck, then the initiate traffic to the generic buffer region 810 may resume in the system.

The initiate flow control mechanism is preferably a performance enhancement to the RedZone flow control technique and the logic used to implement the enhancement mechanism utilizes the RZ counters 730 of the RedZone flow control for the HS-to-GPIN path. In addition, each output port 770 of the HS 400 includes an initiate counter 790 (Init_Cnt) that keeps track of the number of initiate commands loaded into the shared GPIN buffer 800. When the initiate commands reach a predetermined (i.e., programmable) threshold, the respective initiate counter 790 asserts an Initiate_State signal 792 to an initiate flow control (FC) logic circuit 794 of the HS. The initiate FC circuit 794, in turn, issues a stop initiate flow control signal (i.e., HS_Init_FC) 796 to each GPOUT controller coupled to the HS. Illustratively, the initiate FC logic 794 comprises an OR gate 795 having inputs coupled to initiate counters 790 associated with the output ports 770 of the HS.

According to the invention, the HS_Init_FC signal 796 instructs the GPOUT arbiter 718 to cease issuing initiate commands that would occupy space in the generic buffer region 810. The HS_Init_FC signal 796 further instructs arbiter 718 to change the arbitration policy from the adapted round-robin selection described above to a policy whereby complete responses are given absolute higher priority over initiators, when both are otherwise available to be transmitted. This prevents the shared HS buffer 800 from being consumed with Q0 commands and facilitates an even “mix” of other virtual channel packets, such as Q1 and Q2 packets, in the HS. The initiate flow control algorithm described below is instantiated for each output port 770 within the HS.

In the illustrative embodiment, each output port 770 includes a Init_Cnt counter 790 in addition to the GP_Q2_Cnt, GP_Q1_Cnt, GP_Q0/Q0Vic_Cnt, GP_QIO_Cnt and GP_Generic_Cnt counters. Each time the output port 770 issues a Q0/Q0Vic or QIO packet to the GPIN controller 390a, it increments, respectively, one of the GP_Q0/Q0Vic_Cnt or GP_QIO_Cnt counters along with the Init_Cnt counter 790. The initiate counter 790 is not incremented in response to issuance of a Q2 or Q1 packet because they are not initiate commands. Notably, the Init_Cnt counter 790 is decremented when a Q0/Q0Vic or QIO acknowledgement signal is received from the GPIN.

Whenever the Init_Cnt counter 790 for a particular output port 770 equals a predetermined threshold, the output port is considered to be in the Init_State, and an Init_State signal 792 is asserted for the port. Note that the predetermined (programmable) default threshold is 8, although other threshold values such as 10, 12 or 14 may be used. If at least one of the eight (8) Init_State booleans is asserted, the initiate FC circuit 794 asserts an HS_Init_FC signal 796 to all GPOUT controllers 390b coupled to the HS 400. Whenever the HS_Init_FC signal is asserted, the GPOUT controller ceases to issue Q0, Q0Vic or QIO channel packets to the generic buffer region 810 of the shared HS buffer 800. Such packets may, however, still be issued to respective entries of the deadlock avoidance region 820 and forward progress region 830. Whenever the Init_State signal 792 is asserted for a particular output port, the HS modifies the arbitration priorities for that port, as described above, such that the Q1 and Q2 channels are assigned absolute higher priority than the Q0, Q0Vic, or Q1 packets. This modification to the arbitration priorities is also implemented by the GPOUT arbiters 718 as well in response to the HS_Init_FC signal 796.

The Init_State signal 792 from an output port 770 is deasserted whenever Init_Cnt drops below the predetermined threshold level (minus two). If none of the eight Init_State signals 792 are asserted, the HS_Init_FC signal 796 is deasserted.

The parameters of the novel technique may be controlled (or disabled) by performing a write operation to a HS control register. This is done by embedding control information in bits <11:8> of the address during a write operation to HS CSR0. If bit <11> is asserted (“1”), the register is modified. Bit <10> enables or disables initiate flow control (e.g., 0= disable, 1= enable). Bits <9:8> set the threshold value (e.g., 0−> count=8, 1−> count=10, 2−> count=12, 3−> count=14).

In summary, the initiate flow control enhancement of the present invention resolves a condition that arises when the number of initiate commands exceeds a predetermined threshold established by the initiate counter. When the predetermined initiate count threshold is exceeded, the FC counter circuit issues an Initiate_State signal 792 that is provided as an input to the initiate FC logic 794. The initiate FC logic translates the Initiate_State signal into a Stop_Initiate signal 796 that is provided to all of the GPOUT controllers in the SMP system. The translated Stop_Initiate flow control signal is provided to each GPOUT controller in each QBB node to effectively stop issuance of initiate commands, yet allow complete responses to propagate through the system. Thus, the inventive mechanism detects a condition that arises when a shared GPIN buffer, which is always a source of congestion in the SMP system, becomes overrun with initiate commands. Thereafter, the initiate flow control mechanism mitigates that condition by delaying further issuance of those commands until sufficient complete response transactions are forwarded over the switch fabric.

The foregoing description has been directed to specific embodiments of the present invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for performing flow control to prevent a shared buffer resource of a switch fabric within a modular multiprocessor system from being saturated with initiator transaction packets, the switch fabric interconnecting a plurality of nodes of the system and configured to transport initiator and responder transaction packets from a global output port of a first node through a hierarchical switch to a global input port of a second node, the method comprising the steps of:
providing one or more initiate counters at the hierarchical switch;
incrementing the initiate counter each time an initiator transaction packet is received at the shared buffer resource of the switch fabric;
if the initiate counter exceeds a predefined threshold, asserting an initiate flow control signal to each global output port of the multiprocessor system;
in response to assertion of the initiate flow control signal, stopping the global output ports of the multiprocessor system from issuing at least some initiator transaction packets, but permitting the global output ports to continue issuing responder transaction packets.

2. The method of claim 1 wherein
the shared buffer resource includes a generic buffer region configured to store both initiator and responder transaction packets and one or more initiator regions configured to store only initiator transaction packets, and
the step of stopping only stops issuance of initiator transaction packets directed to the generic buffer region, thereby permitting continued issuance of initiator transaction packets directed to the one or more initiator regions.

3. The method of claim 2 wherein the shared buffer resource subject to flow control is disposed at a global input port.

4. The method of claim 3 further comprising the step of decrementing the initiate counter in response to receiving an acknowledgement from the global input port that the initiator transaction packet has been removed from the shared buffer resource.

5. The method of claim 4 wherein
each node of the multiprocessor system includes at least one global input port and at least one global output port,
the hierarchical switch includes at least one output port associated with each global input port,
a separate initiate counter is provided for each global input port, and
when an initiator transaction packet is issued from the hierarchical switch to a given global input port, the respective initiate counter is incremented.

6. The method of claim 5 wherein the initiate flow control signal is asserted whenever any of the initiate counters at the hierarchical switch exceeds the predefined threshold.

7. The method of claim 6 further comprising the step of deasserting the initiate flow control signal provided that all of the initiate counters are below the predefined threshold.

8. The method of claim 7 wherein the flow control signal is received at an arbiter at each global output port, and, if asserted, triggers the arbiter to prevent the global output port from issuing further initiator transaction packets to the generic buffer region of the shared buffer resource.

9. The method of claim 8 further comprising the step of providing absolute priority to the issuance of responder transaction packets over initiator transaction packets, in response to the assertion of the initiate flow control signal.

10. The method of claim 9 wherein
the initiator transaction packets include programmed input/output (I/O) read and write transactions (QIO), processor command requests for memory space read transactions (Q0), and processor command requests for memory space write transaction (Q0Vic), and
the responder transaction packets include ordered and unordered responses to QIO, Q0 and Q0Vic requests.

11. The method of claim 10 wherein the one or more initiator regions of the shared buffer resource include a forward progress guarantee region configured to store QIO initiator transaction packets and a portion of a deadlock avoidance region configured to store Q0 and Q0Vic initiator transaction packets.

12. A switch fabric for interconnecting a plurality of nodes of a modular multi-processor system, the nodes configured to source and receive initiator and responder transaction packets, the switch fabric comprising:
a shared buffer resource for storing transaction packets received by a node of the multiprocessor system;
at least one initiate counter that is incremented each time an initiator transaction packet is issued to the shared buffer resource;
an initiate flow control circuit coupled to the at least one initiate counter, the initiate flow control circuit configured to assert an initiate flow control signal whenever the initiate counter exceeds a predefined threshold; and
means, responsive to the assertion of the initiate flow control signal, for stopping the nodes of the multiprocessor system from issuing at least some initiator transaction packets, but permitting the nodes to continue issuing responder transaction packets.

13. The switch fabric of claim 12 wherein the shared buffer resource includes a generic buffer region configured to store both initiator and responder transaction packets and one or more initiator regions configured to store only initiator transaction packets, and
the means for stopping only stops issuance of initiator transaction packets directed to the generic buffer region, thereby permitting continued issuance of initiator transaction packets directed to the one or more initiator regions.

14. The switch fabric of claim 13 wherein the at least one initiate counter is decremented in response to an acknowledgement indicating that an initiator transaction packet has been removed from the shared buffer resource.

15. The switch fabric of claim 14 wherein
each node of the multiprocessor system includes a shared buffer resource,
an initiate counter is associated with each shared buffer resource,
the initiate flow control circuit asserts the initiate flow control signal whenever any of the initiate counters exceeds the predefined threshold.

16. The switch fabric of claim 15 wherein the initiate flow control circuit deasserts the initiate flow control signal provided that all of the initiate counters are below the predefined threshold.

17. The switch fabric of claim 16 further comprising an arbiter disposed at each global output port, and configured to receive the initiate flow control signal and to prevent the global output port from issuing further initiator transaction packets to the generic buffer region of the shared buffer resource, if the initiate flow control signal is asserted.

18. The switch fabric of claim 17 wherein the arbiter grants absolute priority to the issuance of responder transaction packets over initiator transaction packets, in response to the assertion of the initiate flow control signal.
